(19) United States
(12) Patent Application Publication
(10) Pub. No.: US 2026/0119389 A1
(43) Pub. Date: Apr. 30, 2026

(54) DYNAMIC MEMORY SHARING BETWEEN XPUS BASED ON SYSTEM HEURISTICS AND REAL TIME ADJUSTMENTS

(71) Applicant: Intel Corporation

(72) Inventors: Sangeeta MANEPALLI, Chandler, AZ (US); Deepak Gandiga SHIVAKUMAR, Beaverton, OR (US); Kristoffer Dale FLEMING, Chandler, AZ (US)

(21) Appl. No.: 19/432,194

(22) Filed: Dec. 24, 2025

(51) Int. Cl. G06F 12/02; G06F 12/0802

(52) U.S. Cl. CPC G06F 12/023; G06F 12/0802

(57) ABSTRACT

A dynamic memory management circuit includes interfaces configured to receive data from a memory subsystem, the data describing memory allocation requests from accelerator processing units during a first time period; and one or more processors coupled to the interfaces and configured to: determine memory space to be allocated to a CPU and the accelerator processing units in accordance with a memory allocation policy. The policy includes: allocating a minimum memory space required for an operating system executed by the CPU; allocating a minimum memory space required by the CPU to fulfill a predefined quality of service requirement; one or more rules to amend memory space to be allocated to the CPU and the accelerator processing units based on the data. The processors are further configured to send an instruction to allocate memory for the CPU and the accelerator processing units in accordance with the determined memory space to be allocated.

### BACKGROUND

Usage of memory, both memory hierarchy and system memory is increasing exponentially due to Artificial Intelligence (AI) and accelerator-based workloads like 3D rendering and content creation. Conventionally, there has been a static limit on how much memory accelerators can pin for continuous use which caps the amount of system memory available to accelerators e.g. Graphics Processing Unit (GPU) can use up to 57% of system memory and Neural Processing Unit (NPU) shares the same part of the system memory as a non-display driver device.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a device in accordance with various aspects;

FIG. 2 shows a method of dynamically managing a memory in accordance with various aspects; and

FIG. 3 shows a method in accordance with various aspects.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

Illustratively, as will be described in more detail below, various aspects may provide for dynamic (system) memory sharing between extended processing units (XPUs) based on system heuristics and real time adjustments. By way of example, various aspects provide a memory allocation that can be dynamically split between central processing unit (CPU) compute and (hardware) accelerators, e.g. via reclaiming (system) memory from an overall (system) memory pool, e.g. based on usage heuristics and survivability needs.

In a conventional system memory in a device including a CPU and one or more accelerators such as a graphics processing unit (GPU), a neural processing unit (NPU), and extended processing unit (XPU), and the like, there is defined a fixed allocation of shared memory to the CPU on the one hand and to the other processing units on the other hand.

Various aspects provide for a dynamic allocation of the memory shared by the CPU and the other processing units (such as e.g. GPU, NPU, XPU, and the like) such that the allocation of the memory to the CPU may be dynamically adapted e.g. to the historic memory requests from the processing units. This dynamic allocation of the shared (system) memory to the CPU and the other the other processing units may improve the performance of the entire system, in particular in high workload in artificial intelligence (AI) computational tasks (performed e.g. by one or more NPUs) and/or graphics computational tasks (performed e.g. by one or more GPUs).

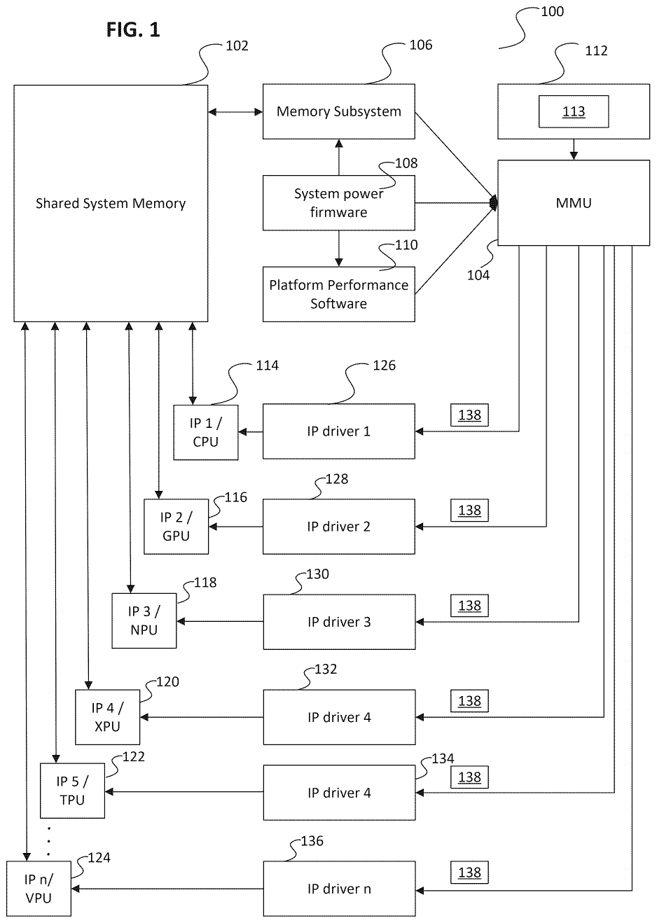

FIG. 1 shows a device 100 in accordance with various aspects. The device may be configured as a system-on-chip (SoC) 100.

The SoC 100 may include a shared memory 102, e.g. shared system memory 102. The shared system memory 102 may include a large number of memory cells, e.g. Random Access Memory (RAM) cells, e.g. Dynamic Random Access Memory (RAM) cells. Exemplary DRAM memory may include LPDDR5/5X or DDR5, however, other DRAM memory or other suitable memory cells may be provided in alternative aspects. By way of example, the shared system memory 102 may have a memory size in the range from e.g. 16 GByte to e.g. 32 GByte, or even more.

The SoC 100 may further include a memory management unit (MMU) 104 (which may also be referred to as memory management circuit, e.g. dynamic memory management circuit), which will be described in more detail below.

The SoC 100 may further include
a memory subsystem 106,
a system power feedback circuit 108,
a platform performance software 110,
a memory (in the following also referred to as global policy memory) 112 (which generally may be any kind of memory of the SoC, e.g. a memory of a BIOS firmware of the SoC) for storing a global policy for managing memory,
a central processing unit (CPU) 114 (and an associated CPU driver circuit 126), and
one or more accelerator processing units 116, 118, 120, 122, 124 (and one or more associated driver circuits 128, 130, 132, 134, 136). The driver circuits 126, 128, 130, 132, 134, 136 may be configured as kernel modules for each accelerator's modular hardware blocks. The driver circuits 126, 128, 130, 132, 134, 136 may be configured to handle initialization, register programming, power gating, interrupt routing, and Direct memory Access (DMA) coordination, exposing/dev interfaces for user-space Application Programming Interfaces (APIs) like OpenCL or oneAPI, for example.

In various aspects, a CPU (e.g. CPU 114) is the primary processor in a computer system, responsible for executing instructions from programs by performing fetch-decode-execute cycles. A CPU may integrate an arithmetic logic unit (ALU) for arithmetic and logic operations, a control unit to coordinate instruction flow and timing, and registers for temporary data storage. A CPU may include one or more processor cores and may further include cache memory (e.g. level 1 cache L1/optionally additionally level 2 cache L2/optionally additionally level 3 cache L3), branch predictors, and pipeline stages to provide instruction-level parallelism and performance. A CPU is configured to manage input/output operations, control peripherals, and interface with a shared (system) memory (e.g. shared memory 102) via an MMU (e.g. the MMU 104).

The one or more accelerator processing units 116, 118, 120, 122, 124 may include one or more of the following accelerator processing units (in general, any number of accelerator processing units may be provided; it is to be noted that the following accelerator processing units only represent exemplary accelerator processing units and other types of accelerator processing units may be provided):
One or more graphics processing units (GPUs) 116 (and one or more respectively associated GPU driver circuits 128). In various aspects, a GPU is a specialized electronic circuit designed to manipulate and alter memory to accelerate the creation of images in a frame buffer intended for output to a display device. A GPU excels at parallel processing, handling thousands of simple tasks simultaneously. A GPU may contain up to thousands or even more processor cores organized into multiprocessors or streaming multiprocessors. These enable high-speed rendering of 2D/3D graphics, video processing, and compute workloads.
One or more neural processing units (NPUs) 118 (and one or more respectively associated NPU driver circuits 130). In various aspects, an NPU is a specialized hardware accelerator designed to execute artificial neural network operations, particularly for artificial intelligence (AI) and machine learning workloads like inference and training. Unlike general-purpose CPUs or parallel-focused GPUs, NPUs mimic brain-like neural structures with optimized modules for matrix multiplications, convolutions, and activations, enabling low-power, high-throughput processing. An NPU features a plurality of dedicated compute units such as multiply-accumulate (MAC) arrays, tensor processor cores, and synaptic weight storage that integrate computation and memory to minimize data movement. An NPU supports data-driven parallel computing, handling scalar, vector, and tensor math in a single instruction for neuron groups.
One or more extended processing units (XPUs) 120 (and one or more respectively associated XPU driver circuits 132). In various aspects, an XPU represents a generalized class of processing units in an heterogeneous computing architecture, encompassing any (hardware) accelerator that a CPU can offload computational tasks to, beyond a GPU or CPU. An XPU enables task-specific acceleration by delegating computational workloads to the most suitable hardware via high-bandwidth interconnects, improving efficiency, power use, and scalability over homogeneous systems.
One or more tensor processing units (TPUs) 122 (and one or more respectively associated TPU driver circuits 134). In various aspects, a TPU is an application-specific integrated circuit (ASIC), optimized as a neural network accelerator for machine learning workloads, particularly tensor operations like matrix multiplications and convolutions in a TensorFlow framework. A TPU may feature a systolic array-based Matrix Multiply Unit (MXU) with up to thousands or more multiply-accumulate (MAC) elements for parallel processing of large tensors, paired with high-bandwidth memory (HBM) and vector/scalar units.
One or more vision processing units (VPUs) 124 (and one or more respectively associated VPU driver circuits 136). In various aspects, a VPU is a specialized hardware accelerator optimized for computer vision tasks, such as real-time image recognition, object detection, video analysis, and edge AI inference using convolutional neural networks (CNNs). A VPU employs parallel vector engines, dedicated convolution hardware, and on-chip memory to minimize data movement.

The driver circuits 126, 128, 130, 132, 134, 136 may be configured to boot firmware on the CPU 114 or the respective one or more accelerator processign units 116, 118, 120, 124, 126, to map buffers via MMU contexts, and to submit command queues asynchronously.

The MMU 104 may be configured to provide virtual-to-physical address translation (mapping) for all units of the SoC 100 using the shared memory 102. Furthermore, the MMU 104 may be configured to provide per-process address spaces, memory page pinning, and Input-Output MMU (IOMMU) protection for secure memory access.

In various aspects, the memory management unit 104 may be configured to dynamically adapt, e.g. dynamically set the allocation of the shared memory 102 between the CPU 114 and the one or more accelerator processing units 116, 118, 120, 122 in accordance with a global memory allocation policy 113. The global memory allocation policy 113 may be stored in the global policy memory 112. It is to be noted, that in various aspects, the global memory allocation policy 113 may be stored in a memory of an SoC (which may include or be a non-volatile memory), in an operating system (OS) e.g. in the Windows OS as part of its registry or as part of a system basic input/output system (BIOS) which can be used by a system power firmware to initialize the system. The global memory allocation policy 113 may include one or more memory allocation rules to be considered or followed by the MMU 104. In other words, the MMU 104 may be configured to determine the memory allocation of the shared (system) memory 102 based on one or more (e.g. all) rules included in the global memory allocation policy 113.

In various aspects, the global memory allocation policy 113 may include one or more of the following rules for the MMU 104 to follow:
Allocating a minimum memory space required for an operating system executed by the central processing unit. This rule instructs the MMU 104 to always keep sufficient system memory space for the CPU (e.g. the CPU 114) that the operating system requires for survivability. By way of example, this minimum memory space always allocated to the CPU (e.g. the CPU 114) is sufficient for the operating system to boot. In various aspects, the minimum memory space may be in the range from about 2 GB to about 8 GB, e.g. in the range from about 3 GB to about 6 GB, e.g. approximately 4 GB.
Allocating a minimum memory space required by the central processing unit (e.g. the CPU 114) to fulfill a predefined quality of service requirement. This rule instructs the MMU 104 to always keep sufficient system memory space for the CPU (e.g. the CPU 114) to provide services (e.g. foreground service(s)) with a sufficient degree of responsiveness. By way of example, this minimum memory space always allocated to the CPU (e.g. the CPU 114) is sufficient, considering current activities (in other words, under current preconditions), to operate with a predefined level of Quality of Service (QoS), e.g. with respect to latency, responsiveness, and the like. Examples for such current activities are the number of currently running applications, a degree of foreground activity (which may also be referred to as foreground screen activity (i.e. activities of the system in front of and visible to a user, e.g. in realtime). The foreground activity may include currently running foreground applications like a web browsing application, an office application, and the like. Another example for such a QoS requirement may include a requirement with respect to system responsiveness. By way of example, the predefined quality of service requirement may include to ensure no loss of responsiveness, e.g. as measured by a so called Procyon Office Productivity Benchmark from UL Solutions. In various aspects, the minimum memory space for this case may be in the range from about 6 GB to about 10 GB, e.g. in the range from about 7 GB to about 9 GB, e.g. approximately 8 GB. It was found that, by way of example, a memory space of remarkably less than the minimum memory space (e.g. of 8 GB) may result in a remarkable performance drop (e.g. a performance drop of 8% of more in accordance with the Procyon Office Productivity Benchmark).
Allocating a minimum memory space required for an accelerator processing unit of the one or more accelerator processing units 116, 118, 120, 122, 124, e.g. for a GPU and/or an NPU. The minimum memory space in this case may include a mimum memory space (e.g. VRAM memory space as part of the shared memory 102) required for operational display and optionally for one application runtime. In various aspects, the minimum memory space for this case may be in the range from about 2 GB to about 6 GB, e.g. in the range from about 3 GB to about 5 GB, e.g. approximately 6 GB. In various aspects, the minimum memory space in this case may include a mimum memory space required for rendering and/or for applications like streaming/content rendering, and the like.
Allocating the minimum memory space(s) for a (respective) predefined minimum allocation time in the shared memory 102. The predefined minimum allocation time may include sufficient time for providing memory compression (e.g. one or more compression thresholds), paging in/out frequencies, and the like. In other words, the predefined minimum allocation time may be dimensioned to ensure an appropriate interaction of the processing units with the shared memory 102.

The shared memory 102, the MMU 104, the CPU 114, the one or more accelerator processing units 116, 118, 120, 122, 124 (and optionally other electronic components of the SoC 100) may be coupled with each other via a scalable fabric.

In various aspects, the global memory allocation policy 113 may include one or more rules to amend memory space to be allocated to the central processing unit and the one or more accelerator processing units 116, 118, 120, 122, 124 based on the data received from the memory subsystem 106.

In various aspects, the memory subsystem 106 may be configured to determine one or more data indicative of previous memory usage (e.g. collecting incoming memory allocation requests (e.g. memory page request(s)) from one or more accelerator processing units of the one or more accelerator processing units 116, 118, 120, 122, 124. In various aspects, a memory page request may include a request for a memory page, e.g. of a predefined memory size, e.g. of a memory (page) size of 4 KB. In various aspects, the memory subsystem 106 may be configured to count the number of incoming memory allocation requests (e.g. memory page request(s)) from one or more (e.g. all) accelerator processing units of the one or more accelerator processing units 116, 118, 120, 122, 124, e.g. during a predefined first time period. The predefined first time period may be in the range of a plurality of ns, e.g. in the range from about 5 ns to about 50 ns, e.g. in the range from about 10 ns to about 40 ns, e.g. approximately 25 ns. The memory subsystem 106 may be configured to send this information (data) to the MMU 104. The MMU 104 may be configured to receive the information (data) from the memory subsystem 106 and to dynamically determine memory space to be allocated (in the shared memory 102) to a central processing unit (e.g. the CPU 114) and the one or more accelerator processing units (e.g. the one or more accelerator processing units 116, 118, 120, 122, 124) in accordance with the memory allocation policy 113 using the received information (data). By way of example, the MMU 104 may be configured to receive (take in) feedback from the memory subsystem 106 for memory requests (incoming to the memory subsystem 106) from the one or more accelerator processing units and may determine a ratio CPU memory usage/accelerator processing unit(s) memory usage, e.g. for the predefined first time period. The MMU 104 may be configured to, if the ratio is below a predefined threshold (e.g. if the ratio is smaller than a threshold being in a range from about 0.1 to about 0.3, e.g. in a range from about 0.15 to about 0.25, e.g. approximately or exactly 0.2), dynamically shift memory space to be allocated to the one or more accelerator processing units.

Optionally, the system power feedback circuit 108 may be configured to determine cache usage data to determine a trend of cache usage per compute and fabric voltage-frequency (VF) operating points to gauge memory subsystem 106 requests trends during a predefined second time period. The predefined second time period may be in the range of a plurality of ms, e.g. in the range from about 5 ms to about 20 ms, e.g. in the range from about 8 ms to about 15 ms, e.g. approximately 10 ms. By way of example, the system power feedback circuit 108 may be configured to transmit the determined cache usage data to the MMU 104. The system power feedback circuit 108 may be part of the firmware of the SoC 100. Illustratively, the system power feedback circuit 108 may be configured to provide feedback on cache usage of the shared memory 102 by the CPU and the one or more accelerator processing units.

Optionally, the platform performance software 110 may be configured to determine data indicating performance of the SoC due to the memory allocation and/or the change of the memory allocation to the CPU and the one or more accelerator processing units (e.g. how did the memory allocation change impact the system (e.g. SoC 100) behavior). The determination may include a prediction of the performance in a future time period, e.g. a predefined third time period. The predefined third time period may be in the range of the inverse of a frame refresh rate of a connected display (e.g. 60 Hz), e.g. in the range of a plurality of ms, e.g. in the range from about 5 ms to about 20 ms, e.g. in the range from about 8 ms to about 18 ms, e.g. approximately 16 ms. In various aspects, the platform performance software 110 may be configured to transmit the determined performance data to the MMU 104. The MMU 104 may be configured to receive the performance data from the platform performance software 110 and to change the allocation of the shared memory 102 between the CPU and the one or more accelerator processing units also taking the received performance data into consideration. The platform performance software 110 may include a software according to a Dynamic tuning technology (DTT software).

Using the data received from the memory subsystem 106, the system power feedback circuit 108, and the platform performance software 110, the MMU 104 may determine an amended memory space allocation for the CPU 114 and the one or more accelerator processing units 116, 118, 120, 122, 124 in accordance with the stored global memory allocation policy 113. Illustratively, the MMU 114 may dynamically adjust the memory space allocation to the CPU 114 and the one or more accelerator processing units 116, 118, 120, 122, 124 using data indication memory usage in the past and optionally in addition predicted memory requirement in the future, always following the memory allocation rules as stored in the global memory allocation policy 113.

After having dermined the (amended, in other words, new) memory space to be allocated to the CPU 114 and the one or more accelerator processing units 116, 118, 120, 122, 124, the MMU 104 instructs the drivers of the CPU 114 and the one or more accelerator processing units 116, 118, 120, 122, 124 about the amended memory allocation of the shared (system) memory 102. By way of example, the MMU 104 may be configured to generate an allocation instruction message 138 which includes the information (e.g. instruction) to allocate the shared (system) memory 102 in accordance with the determined amended memory allocation and send the same to the driver circuit 126 of the CPU 114 and to the driver circuits 128, 130, 132, 134, 136 of the one or more accelerator processing units 116, 118, 120, 122, 124. The driver circuits 126, 128, 130, 132, 134, 136 receive the allocation instruction message 138 and control the CPU 114 and the driver circuits 128, 130, 132, 134, 136 accordingly.

By way of example, the allocation instruction message 138 may illustratively include a request to the CPU 114 and/or the respective one or more accelerator processing units 116, 118, 120, 122, 124, per per context, to reclaim memory if allocation of the memory space requires more than the minimum memory soace that is currently available. Each of the CPU 114 and/or the one or more accelerator processing units 116, 118, 120, 122, 124 keeps track of and notifies the MMU 104 of the total memory used across all contexts. Furthermore, Each of the CPU 114 and/or the one or more accelerator processing units 116, 118, 120, 122, 124 adjusts dynamic memory usage and may tag memory for being paged out if not used (e.g. if context moves to a background activity or background process).

It is to be noted that in various aspects, the shared memory 102 may be by the CPU 114 and/or the one or more accelerator processing units 116, 118, 120, 122, 124 using one or more xPU adaptors such that, based on priority the MMU 104 can page in/out memory space of the shared memory 102.

By way of example, various aspects provide:
1. A global system level policy that allows a memory management unit (e.g. the MMU 104) to change memory available to one or more accelerator processing units (e.g. GPUS, NPUs, TPUs, XPUs, VPUs, and the like) based e.g. on bookend heuristics and past usage trends.
2. Driver kernel and/or user mode changes to accommodate memory management interactions for reclaiming memory related to specific contexts.
3. Multi-IP awareness of shared memory usage to prevent device out of memory or device lost issues.
4. Minimum memory allocated/reserved for CPU for survivability based on understanding on common user activity on the system (from “Day in Life” persona studies)

Various aspects may provide one or both of the following effects:
1. Charting a path to unified memory architecture, first time on e.g. windows-based systems.
2. Minimize cost of higher system memory capacities for OEMs and make efficient use of existing memory on latest shipped computational platforms.

Benefit of dynamic memory has been simulated at system level to show 10%-4× or more improvement in AI token rate when concurrent workloads are run on CPU and GPU (see the following table):

| | | | CPU | GPU Mem | | CPU/Total Mem | |
|---|---|---|---|---|---|---|---|
| | Memory | | MB/s, Avg | (D3D | | MB | |
| Workload | Split | | tok/s 3 | Residency | | Active | CPU |
| Setup | (CPU:GPU) | Workload | runs | Llama | Qwen | List | MemScale |
| I. CPU | 9.2G | synthetic | 23643 | — | — | 10898 | 4096 |
| | (43:57) | CPU | [23571-23668] - | | | | |
| | | benchmark - | R1 | | | | |
| | | 2GB | | | | | |
| | | buffer in | | | | | |
| | | memory | | | | | |
| | 11.2G | synthetic | 24045 | — | — | 9996 | 4096 |
| | (30:70) | CPU | [23709-24709] - | | | | |
| | | benchmark - | R1 | | | | |
| | | 2GB | | | | | |
| | | buffer in | | | | | |
| | | memory | | | | | |
| II. GPU | 9.2G | 1. | 14.46 | 6337 | — | 15601 | — |
| | (43:57) | Llama3.1- | [14.39-14.54] | | | | |
| | | 8B | | | | | |
| | | 2. Qwen3- | 19.21 | — | 4943 | 14689 | — |
| | | 1.7B | [19.10-19.38] | | | | |
| | | 3. Lllama + | 1.79 | 5130 | 3631 | 14869 | — |
| | | Qwen | [1.74-1.83], | | | | |
| | | | 7.61 | | | | |
| | | | [7.36-7.80] | | | | |
| | 11.2G | 1. | 16.04 | 6556 | — | 15593 | — |
| | (30:70) | Llama3.1- | [15.32-16.62] - | | | | |
| | | 8B | R2 | | | | |
| | | 2. Qwen3- | 19.68 | — | 4801 | 13428 | — |
| | | 1.7B | [19.46-19.92] | | | | |
| | | 3. Lllama + | 7.56 | 6258 | 4374 | 15944 | — |
| | | Qwen | [7.51-7.62], | | | | |
| | | | 9.63 | | | | |
| | | | [9.51-9.76] - | | | | |
| | | | R3 | | | | |

### Remarks

R1: Synthetic CPU benchmark scores as measured by memory bandwidth to the allocated 2 GB buffer stay consistent when there is no GPU workload.
R2: AI models, running individually show up to 10% higher token rate with more memory capacity allocated to GPU.
R3: AI models, running jointly, show up to 4.2 times higher token rate with more memory capacity allocated to GPU.
Setup:
   CPU: Lunar Lake
   Memory: LPDDR5 16 GB
   Power Mode: DC Bal
   GPU WLs: Llama 3.1-8B(int4)+Qwen3-1.7B(fp8)
   CPU WL: Synthetic CPU benchmark scores as measured by memory bandwidth to the allocated 2 GB buffer

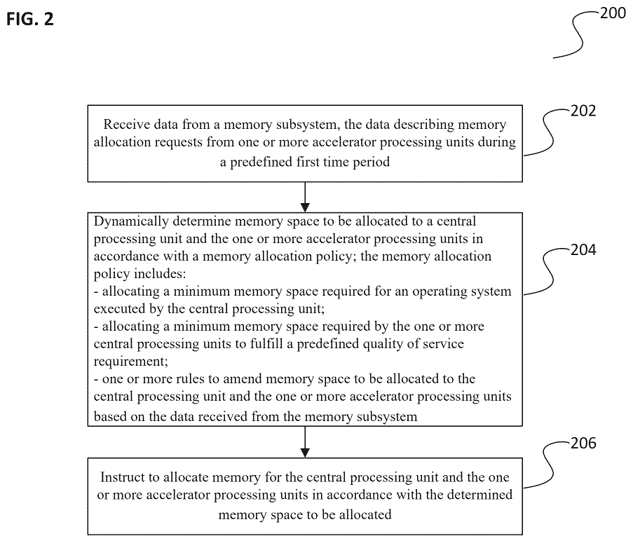

FIG. 2 shows a method 200 of dynamically managing a memory. The method 200 may include, in 202, receiving data from a memory subsystem, the data describing memory allocation requests from one or more accelerator processing units during a predefined first time period, and, in 204, dynamically determining memory space to be allocated to a central processing unit and the one or more accelerator processing units in accordance with a memory allocation policy. The memory allocation policy includes: allocating a minimum memory space required for an operating system executed by the central processing unit; allocating a minimum memory space required by the one or more central processing units to fulfill a predefined quality of service requirement; one or more rules to amend memory space to be allocated to the central processing unit and the one or more accelerator processing units based on the data received from the memory subsystem. The method may further include, in 206, instructing to allocate memory for the central processing unit and the one or more accelerator processing units in accordance with the determined memory space to be allocated.

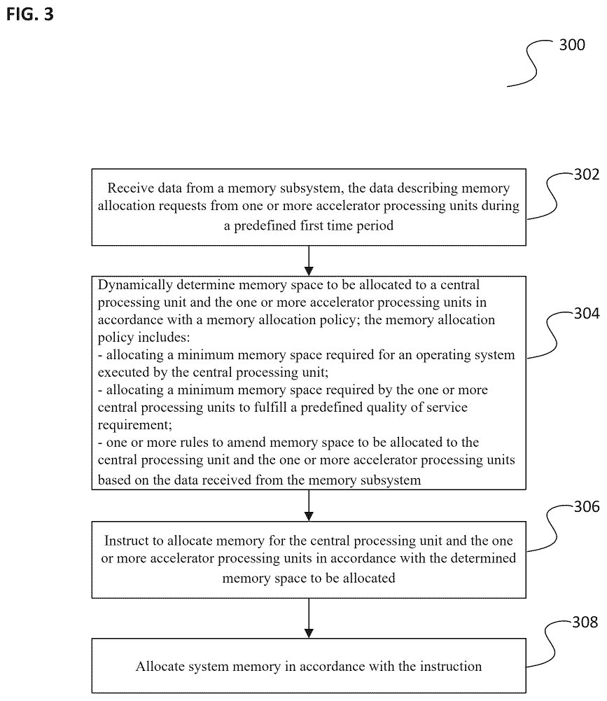

FIG. 3 shows a method 300. The method 300 may include a method of dynamically managing a memory, including, in 302, receiving data from a memory subsystem, the data describing memory allocation requests from one or more accelerator processing units during a predefined first time period; and, in 304, dynamically determining memory space to be allocated to a central processing unit and the one or more accelerator processing units in accordance with a memory allocation policy. The memory allocation policy includes: allocating a minimum memory space required for an operating system executed by the central processing units; allocating a minimum memory space required by the central processing unit to fulfill a predefined quality of service requirement; one or more rules to amend memory space to be allocated to the central processing unit and the one or more accelerator processing units based on the data received from the memory subsystem. The method of dynamically managing a memory may further include, in 306, instructing a system memory to allocate memory for the central processing unit and the one or more accelerator processing units in accordance with the determined memory space to be allocated. The method may further include, in 308, allocating system memory in accordance with the instruction.

In the following, various aspects of this disclosure will be illustrated:

Example 1 is a dynamic memory management circuit. The dynamic memory management circuit may include one or more interfaces configured to receive data from a memory subsystem, the data describing memory allocation requests from one or more accelerator processing units during a predefined first time period; and one or more processors coupled to the one or more interfaces and configured to: dynamically determine memory space to be allocated to a central processing unit and the one or more accelerator processing units in accordance with a memory allocation policy. The memory allocation policy includes: allocating a minimum memory space required for an operating system executed by the central processing unit; allocating a minimum memory space required by the central processing unit to fulfill a predefined quality of service requirement; one or more rules to amend memory space to be allocated to the central processing unit and the one or more accelerator processing units based on the data received from the memory subsystem. The one or more processors are further configured to send an instruction to allocate memory for the central processing unit and the one or more accelerator processing units in accordance with the determined memory space to be allocated.

In Example 2, the subject matter of Example 1 can optionally include that the predefined quality of service requirement includes a requirement to ensure a sufficient responsiveness in an execution of one or more application programs; one or more foreground activity programs; and/or one or more system programs.

In Example 3, the subject matter of any one of Examples 1 or 2 can optionally include that the memory allocation policy further includes allocating a minimum memory space required for an operational display for rendering information on a display.

In Example 4, the subject matter of any one of Examples 1 to 3 can optionally include that the memory allocation policy further includes allocating the minimum memory spaces for a predefined minimum allocation time.

In Example 5, the subject matter of any one of Examples 1 to 4 can optionally include that the one or more interfaces are further configured to receive cache usage data from a circuit, the cache usage data describing a usage of a cache memory during a predefined second time period. The memory allocation policy includes one or more rules to change the allocation based on the data received from the circuit.

In Example 6, the subject matter of any one of Examples 1 to 5 can optionally include that the circuit includes or is a firmware.

In Example 7, the subject matter of any one of Examples 5 or 6 can optionally include that the circuit includes or is a system power feedback circuit.

In Example 8, the subject matter of any one of Examples 5 to 7 can optionally include that the data received from the circuit includes data indicating fabric voltage-frequency (VF) operating points.

In Example 9, the subject matter of any one of Examples 1 to 8 can optionally include that the one or more interfaces are further configured to receive data from a platform performance software. The memory allocation policy includes one or more rules to change the allocation based on the data received from the platform performance software.

In Example 10, the subject matter of any one of Examples 1 to 9 can optionally include that the one or more accelerator processing units are one or more accelerator processing units selected from a group consisting of: one or more graphics processing units (GPU); one or more neural processing units (NPU); one or more tensor processing units (TPU); one or more vision processing units (VPU); and one or more extended processing units (XPU).

In Example 11, the subject matter of any one of Examples 1 to 10 can optionally include that the one or more processors are further configured to indicate to one or more driver circuits the allocated memory for the one or more accelerator processing units.

In Example 12, the subject matter of any one of Examples 1 to 11 can optionally include that the memory management circuit is configured as a system-on-chip.

Example 13 is a system. The system may include a dynamic memory management circuit. The dynamic memory management circuit may include one or more interfaces configured to receive data from a memory subsystem, the data describing memory allocation requests from one or more accelerator processing units during a predefined first time period; and one or more processors coupled to the one or more interfaces and configured to: dynamically determine memory space to be allocated to a central processing unit and the one or more accelerator processing units in accordance with a memory allocation policy. The memory allocation policy includes: allocating a minimum memory space required for an operating system executed by the central processing unit; allocating a minimum memory space required by the central processing unit to fulfill a predefined quality of service requirement; one or more rules to amend memory space to be allocated to the central processing unit and the one or more accelerator processing units based on the data received from the memory subsystem. The one or more processors are further configured to instruct to allocate memory for the central processing unit and the one or more accelerator processing units in accordance with the determined memory space to be allocated. The system further includes system memory coupled to the dynamic memory management circuit.

In Example 14, the subject matter of Example 13 can optionally include that the system further includes the central processing unit coupled to the system memory. The central processing unit may be configured to dynamically adjust its memory allocation in accordance with the instruction from the one or more processors.

In Example 15, the subject matter of any one of Examples 13 or 14 can optionally include that the system further includes the one or more accelerator processing units coupled to the system memory. Each accelerator processing unit of the one or more accelerator processing units may be configured to dynamically adjust its memory allocation in accordance with the instruction from the one or more processors.

In Example 16, the subject matter of any one of Examples 13 to 15 can optionally include that the system memory includes random access memory (RAM).

In Example 17, the subject matter of any one of Examples 13 to 16 can optionally include that the predefined quality of service requirement includes a requirement to ensure a sufficient responsiveness in an execution of: one or more application programs; one or more foreground activity programs; and/or one or more system programs.

In Example 18, the subject matter of any one of Examples 13 to 17 can optionally include that the memory allocation policy further includes allocating a minimum memory space required for an operational display for rendering information on a display.

In Example 19, the subject matter of any one of Examples 13 to 18 can optionally include that the memory allocation policy further includes allocating the minimum memory spaces for a predefined minimum allocation time.

In Example 20, the subject matter of any one of Examples 13 to 19 can optionally include that the one or more interfaces are further configured to receive cache usage data from a circuit, the cache usage data describing a usage of a cache memory during a predefined second time period. The memory allocation policy includes one or more rules to change the allocation based on the data received from the circuit.

In Example 21, the subject matter of any one of Examples 13 to 20 can optionally include that the circuit includes or is a firmware.

In Example 22, the subject matter of any one of Examples 20 or 21 can optionally include that the circuit includes or is a system power feedback circuit.

In Example 23, the subject matter of any one of Examples 13 to 22 can optionally include that the data received from the circuit include data indicating fabric voltage-frequency (VF) operating points.

In Example 24, the subject matter of any one of Examples 13 to 23 can optionally include that the one or more interfaces are further configured to receive data from a platform performance software. The memory allocation policy includes one or more rules to change the allocation based on the data received from the platform performance software.

In Example 25, the subject matter of any one of Examples 13 to 24 can optionally include that the one or more accelerator processing units are one or more accelerator processing units selected from a group consisting of: one or more graphics processing units (GPU); one or more neural processing units (NPU); one or more tensor processing units (TPU); one or more vision processing units (VPU); and one or more extended processing units (XPU).

In Example 26, the subject matter of any one of Examples 13 to 25 can optionally include that the one or more processors are further configured to indicate to one or more driver circuits the allocated memory for the one or more accelerator processing units.

Example 27 is a method of dynamically managing a memory. The method may include: receiving data from a memory subsystem, the data describing memory allocation requests from one or more accelerator processing units during a predefined first time period; dynamically determining memory space to be allocated to a central processing unit and the one or more accelerator processing units in accordance with a memory allocation policy. The memory allocation policy includes: allocating a minimum memory space required for an operating system executed by the central processing unit; allocating a minimum memory space required by the one or more central processing units to fulfill a predefined quality of service requirement; one or more rules to amend memory space to be allocated to the central processing unit and the one or more accelerator processing units based on the data received from the memory subsystem. The method may further include instructing to allocate memory for the central processing unit and the one or more accelerator processing units in accordance with the determined memory space to be allocated.

In Example 28, the subject matter of Example 27 can optionally include that the predefined quality of service requirement includes a requirement to ensure a sufficient responsiveness in an execution of: one or more application programs; one or more foreground activity programs; and/or one or more system programs.

In Example 29, the subject matter of any one of Examples 27 or 28 can optionally include that the memory allocation policy further includes allocating a minimum memory space required for an operational display for rendering information on a display.

In Example 30, the subject matter of any one of Examples 27 to 29 can optionally include that the memory allocation policy further includes allocating the minimum memory spaces for a predefined minimum allocation time.

In Example 31, the subject matter of any one of Examples 27 to 30 can optionally include that the one or more interfaces are further configured to receive cache usage data from a circuit, the cache usage data describing a usage of a cache memory during a predefined second time period. The memory allocation policy includes one or more rules to change the allocation based on the data received from the circuit.

In Example 32, the subject matter of any one of Examples 27 to 31 can optionally include that the circuit includes or is a firmware.

In Example 33, the subject matter of any one of Examples 31 or 32 can optionally include that the circuit includes or is a system power feedback circuit.

In Example 34, the subject matter of any one of Examples 31 to 33 can optionally include that the data received from the circuit include data indicating fabric voltage-frequency (VF) operating points.

In Example 35, the subject matter of any one of Examples 27 to 34 can optionally include that the one or more interfaces are further configured to receive data from a platform performance software. The memory allocation policy includes one or more rules to change the allocation based on the data received from the platform performance software.

In Example 36, the subject matter of any one of Examples 27 to 35 can optionally include that the one or more accelerator processing units are one or more accelerator processing units selected from a group consisting of: one or more graphics processing units (GPU); one or more neural processing units (NPU); one or more tensor processing units (TPU); one or more vision processing units (VPU); and one or more extended processing units (XPU).

In Example 37, the subject matter of any one of Examples 27 to 36 can optionally include that the one or more processors are further configured to indicate to one or more driver circuits the allocated memory for the one or more accelerator processing units.

In Example 38, the subject matter of any one of Examples 27 to 37 can optionally include that the method is implemented on a system-on-chip.

Example 39 is a method. The method may include: a method of dynamically managing a memory, including: receiving data from a memory subsystem, the data describing memory allocation requests from one or more accelerator processing units during a predefined first time period; and dynamically determining memory space to be allocated to a central processing unit and the one or more accelerator processing units in accordance with a memory allocation policy. The memory allocation policy includes: allocating a minimum memory space required for an operating system executed by the central processing units; allocating a minimum memory space required by the central processing unit to fulfill a predefined quality of service requirement; one or more rules to amend memory space to be allocated to the central processing unit and the one or more accelerator processing units based on the data received from the memory subsystem. The method of dynamically managing a memory may further include instructing a system memory to allocate memory for the central processing unit and the one or more accelerator processing units in accordance with the determined memory space to be allocated. The method may further include allocating system memory in accordance with the instruction.

In Example 40, the subject matter of Example 39 can optionally include that the central processing unit is coupled to the system memory.

In Example 41, the subject matter of any one of Examples 39 or 40 can optionally include that the one or more accelerator processing units are coupled to the system memory.

In Example 42, the subject matter of any one of Examples 39 to 41 can optionally include that the system memory includes random access memory (RAM).

In Example 43, the subject matter of any one of Examples 39 to 42 can optionally include that the predefined quality of service requirement includes a requirement to ensure a sufficient responsiveness in an execution of: one or more application programs; one or more foreground activity programs; and/or one or more system programs.

In Example 44, the subject matter of any one of Examples 39 to 43 can optionally include that the memory allocation policy further includes allocating a minimum memory space required for an operational display for rendering information on a display.

In Example 45, the subject matter of any one of Examples 39 to 44 can optionally include that the memory allocation policy further includes allocating the minimum memory spaces for a predefined minimum allocation time.

In Example 46, the subject matter of any one of Examples 39 to 45 can optionally include that the one or more interfaces are further configured to receive cache usage data from a circuit, the cache usage data describing a usage of a cache memory during a predefined second time period. The memory allocation policy includes one or more rules to change the allocation based on the data received from the circuit.

In Example 47, the subject matter of any one of Examples 39 to 46 can optionally include that the circuit includes or is a firmware.

In Example 48, the subject matter of any one of Examples 46 or 47 can optionally include that the circuit includes or is a system power feedback ircuit.

In Example 49, the subject matter of any one of Examples 46 to 48 can optionally include that the data received from the circuit include data indicating fabric voltage-frequency (VF) operating points.

In Example 50, the subject matter of any one of Examples 39 to 49 can optionally include that the one or more interfaces are further configured to receive data from a platform performance software. The memory allocation policy includes one or more rules to change the allocation based on the data received from the platform performance software.

In Example 51, the subject matter of any one of Examples 39 to 50 can optionally include that the one or more accelerator processing units are one or more accelerator processing units selected from a group consisting of: one or more graphics processing units (GPU); one or more neural processing units (NPU); one or more tensor processing units (TPU); one or more vision processing units (VPU); and one or more extended processing units (XPU).

In Example 52, the subject matter of any one of Examples 39 to 51 can optionally include that the one or more processors are further configured to indicate to one or more driver circuits the allocated memory for the one or more accelerator processing units.

Example 53 is a computer readable medium storing instructions which, when executed by a processor, implement a method of any one of Examples 27 to 51.

Example 54 is a dynamic memory management circuit. The dynamic memory management circuit may include: means for receiving data from a memory subsystem, the data describing memory allocation requests from one or more accelerator processing units during a predefined first time period; means for dynamically determining memory space to be allocated to a central processing unit and the one or more accelerator processing units in accordance with a memory allocation policy. The memory allocation policy includes: allocating a minimum memory space required for an operating system executed by the central processing unit; allocating a minimum memory space required by the central processing unit to fulfill a predefined quality of service requirement; one or more rules to amend memory space to be allocated to the central processing unit and the one or more accelerator processing units based on the data received from the memory subsystem. The dynamic memory management circuit may further include means for instructing to allocate memory for the central processing unit and the one or more accelerator processing units in accordance with the determined memory space to be allocated.

In Example 55, the subject matter of Example 54 can optionally include that the predefined quality of service requirement includes a requirement to ensure a sufficient responsiveness in an execution of: one or more application programs; one or more foreground activity programs; one or more system programs.

In Example 56, the subject matter of any one of Examples 54 or 55 can optionally include that the memory allocation policy further includes allocating a minimum memory space required for an operational display for rendering information on a display.

In Example 57, the subject matter of any one of Examples 54 to 56 can optionally include that the memory allocation policy further includes allocating the minimum memory spaces for a predefined minimum allocation time.

In Example 58, the subject matter of any one of Examples 54 to 57 can optionally include that the memory management circuit further includes means for receiving cache usage data from a circuit, the cache usage data describing a usage of a cache memory during a predefined second time period. The memory allocation policy includes one or more rules to change the allocation based on the data received from the circuit.

In Example 59, the subject matter of any one of Examples 54 to 58 can optionally include that the circuit includes or is a firmware.

In Example 60, the subject matter of any one of Examples 58 or 59 can optionally include that the circuit includes or is a system power feedback circuit.

In Example 61, the subject matter of any one of Examples 58 to 60 can optionally include that the data received from the circuit include data indicating fabric voltage-frequency (VF) operating points.

In Example 62, the subject matter of any one of Examples 54 to 61 can optionally include that the memory management circuit further includes means for receiving data from a platform performance software. The memory allocation policy includes one or more rules to change the allocation based on the data received from the platform performance software.

In Example 63, the subject matter of any one of Examples 54 to 62 can optionally include that the one or more accelerator processing units are one or more accelerator processing units selected from a group consisting of: one or more graphics processing units (GPU); one or more neural processing units (NPU); one or more tensor processing units (TPU); one or more vision processing units (VPU); and one or more extended processing units (XPU).

In Example 64, the subject matter of any one of Examples 54 to 63 can optionally include that the memory management circuit further includes means for indicating to one or more driver circuits the allocated memory for the one or more accelerator processing units.

In Example 65, the subject matter of any one of Examples 54 to 64 can optionally include that the memory management circuit is configured as a system-on-chip.

Example 66 is a system. The system may include a dynamic memory management circuit. The dynamic memory management circuit may include means for receiving data from a memory subsystem, the data describing memory allocation requests from one or more accelerator processing units during a predefined first time period; means for dynamically determining memory space to be allocated to a central processing unit and the one or more accelerator processing units in accordance with a memory allocation policy. The memory allocation policy includes: allocating a minimum memory space required for an operating system executed by the central processing unit; allocating a minimum memory space required by the central processing unit to fulfill a predefined quality of service requirement; one or more rules to amend memory space to be allocated to the central processing unit and the one or more accelerator processing units based on the data received from the memory subsystem. The dynamic memory management circuit further includes means for instructing to allocate memory for the central processing unit and the one or more accelerator processing units in accordance with the determined memory space to be allocated. The system further includes system memory coupled to the dynamic memory management circuit.

In Example 67, the subject matter of Example 66 can optionally include that the system further includes the central processing unit coupled to the system memory.

In Example 68, the subject matter of any one of Examples 66 or 67 can optionally include that the system further includes the one or more accelerator processing units coupled to the system memory.

In Example 69, the subject matter of any one of Examples 66 to 68 can optionally include that the system memory includes random access memory (RAM).

In Example 70, the subject matter of any one of Examples 66 to 69 can optionally include that the predefined quality of service requirement includes a requirement to ensure a sufficient responsiveness in an execution of: one or more application programs; one or more foreground activity programs; one or more system programs.

In Example 71, the subject matter of any one of Examples 66 to 70 can optionally include that the memory allocation policy further includes allocating a minimum memory space required for an operational display for rendering information on a display.

In Example 72, the subject matter of any one of Examples 66 to 71 can optionally include that the memory allocation policy further includes allocating the minimum memory spaces for a predefined minimum allocation time.

In Example 73, the subject matter of any one of Examples 66 to 72 can optionally include that the system further includes means for receiving cache usage data from a circuit, the cache usage data describing a usage of a cache memory during a predefined second time period. The memory allocation policy includes one or more rules to change the allocation based on the data received from the circuit.

In Example 74, the subject matter of Example 73 can optionally include that the circuit includes or is a firmware.

In Example 75, the subject matter of any one of Examples 73 or 74 can optionally include that the circuit includes or is a system power feedback circuit.

In Example 76, the subject matter of any one of Examples 66 to 75 can optionally include that the data received from the circuit include data indicating fabric voltage-frequency (VF) operating points.

In Example 77, the subject matter of any one of Examples 66 to 76 can optionally include that the system further includes means for receiving data from a platform performance software. The memory allocation policy includes one or more rules to change the allocation based on the data received from the platform performance software.

In Example 78, the subject matter of any one of Examples 66 to 77 can optionally include that the one or more accelerator processing units are one or more accelerator processing units selected from a group consisting of: one or more graphics processing units (GPU); one or more neural processing units (NPU); one or more tensor processing units (TPU); one or more vision processing units (VPU); and one or more extended processing units (XPU).

In Example 79, the subject matter of any one of Examples 66 to 78 can optionally include that the one or more processors are further configured to indicate to one or more driver circuits the allocated memory for the one or more accelerator processing units.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A dynamic memory management circuit, comprising:
one or more interfaces configured to receive data from a memory subsystem, the data describing memory allocation requests from one or more accelerator processing units during a predefined first time period;
one or more processors coupled to the one or more interfaces and configured to:
dynamically determine memory space to be allocated to a central processing unit and the one or more accelerator processing units in accordance with a memory allocation policy
wherein the memory allocation policy comprises:
allocating a minimum memory space required for an operating system executed by the central processing unit;
allocating a minimum memory space required by the central processing unit to fulfill a predefined quality of service requirement;
one or more rules to amend memory space to be allocated to the central processing unit and the one or more accelerator processing units based on the data received from the memory subsystem;
send an instruction to allocate memory for the central processing unit and the one or more accelerator processing units in accordance with the determined memory space to be allocated.

2. The memory management circuit of claim 1,
wherein the predefined quality of service requirement comprises a requirement to ensure a sufficient responsiveness in an execution of
one or more application programs;
one or more foreground activity programs;
one or more system programs.

3. The memory management circuit of claim 1,
wherein the memory allocation policy further comprises allocating a minimum memory space required for an operational display for rendering information on a display.

4. The memory management circuit of claim 1,
wherein the memory allocation policy further comprises allocating the minimum memory spaces for a predefined minimum allocation time.

5. The memory management circuit of claim 1,
wherein the one or more interfaces are further configured to receive cache usage data from a circuit, the cache usage data describing a usage of a cache memory during a predefined second time period; and
wherein the memory allocation policy comprises one or more rules to change the allocation based on the data received from the circuit.

6. The memory management circuit of claim 1,
wherein the circuit comprises or is a firmware.

7. The memory management circuit of claim 1,
wherein the one or more interfaces are further configured to receive data from a platform performance software; and
wherein the memory allocation policy comprises one or more rules to change the allocation based on the data received from the platform performance software.

8. The memory management circuit of claim 1,
wherein the one or more accelerator processing units are one or more accelerator processing units selected from a group consisting of:
one or more graphics processing units (GPU);
one or more neural processing units (NPU);
one or more tensor processing units (TPU);
one or more vision processing units (VPU); and
one or more extended processing units (XPU).

9. The memory management circuit of claim 1,
wherein the one or more processors are further configured to indicate to one or more driver circuits the allocated memory for the one or more accelerator processing units.

10. The memory management circuit of claim 1,
configured as a system-on-chip.

11. A system, comprising:
a dynamic memory management circuit, comprising
one or more interfaces configured to receive data from a memory subsystem, the data describing memory allocation requests from one or more accelerator processing units during a predefined first time period;
and one or more processors coupled to the one or more interfaces and configured to:
dynamically determine memory space to be allocated to a central processing unit and the one or more accelerator processing units in accordance with a memory allocation policy, the memory allocation policy comprising:
allocating a minimum memory space required for an operating system executed by the central processing unit;
allocating a minimum memory space required by the central processing unit to fulfill a predefined quality of service requirement;
one or more rules to amend memory space to be allocated to the central processing unit and the one or more accelerator processing units based on the data received from the memory subsystem;
wherein the one or more processors are further configured to instruct to allocate memory for the central processing unit and the one or more accelerator processing units in accordance with the determined memory space to be allocated;
the system further comprising system memory coupled to the dynamic memory management circuit.

12. The system of claim 11, further comprising:
the central processing unit coupled to the system memory;
wherein the central processing unit is configured to dynamically adjust its memory allocation in accordance with the instruction from the one or more processors.

13. The system of claim 11, further comprising:
the one or more accelerator processing units coupled to the system memory;
wherein each accelerator processing unit of the one or more accelerator processing units is configured to dynamically adjust its memory allocation in accordance with the instruction from the one or more processors.

14. The system of claim 11, further comprising:
wherein the one or more processors are further configured to indicate to one or more driver circuits the allocated memory for the one or more accelerator processing units.

15. A dynamic memory management circuit, comprising:
means for receiving data from a memory subsystem, the data describing memory allocation requests from one or more accelerator processing units during a predefined first time period;
means for dynamically determining memory space to be allocated to a central processing unit and the one or more accelerator processing units in accordance with a memory allocation policy
wherein the memory allocation policy comprises:
allocating a minimum memory space required for an operating system executed by the central processing units;
allocating a minimum memory space required by the one or more central processing units to fulfil a predefined quality of service requirement;
one or more rules to amend memory space to be allocated to the central processing unit and the one or more accelerator processing units based on the data received from the memory subsystem;
means for instructing to allocate memory for the one or more CPU and the one or more accelerator processing units in accordance with the determined memory space to be allocated.

16. The memory management circuit of claim 15,
wherein the predefined quality of service requirement comprises a requirement to ensure a sufficient responsiveness in an execution of
one or more application programs;
one or more foreground activity programs;
one or more system programs.

17. The memory management circuit of claim 15,
wherein the memory allocation policy further comprises allocating a minimum memory space required for an operational display for rendering information on a display.

18. The memory management circuit of claim 15,
wherein the memory allocation policy further comprises allocating the minimum memory spaces for a predefined minimum allocation time.

19. The memory management circuit of claim 15, further comprising:
means for receiving cache usage data from a circuit, the cache usage data describing a usage of a cache memory during a predefined second time period;
wherein the memory allocation policy comprises one or more rules to change the allocation based on the data received from the circuit.

20. The memory management circuit of claim 15, further comprising:
means for receiving data from a platform performance software;
wherein the memory allocation policy comprises one or more rules to change the allocation based on the data received from the platform performance software.
